(19) United States
(12) Patent Application Publication
(10) Pub. No.: US 2006/0007405 A1
(43) Pub. Date: Jan. 12, 2006

(54) Adjustment apparatus

(76) Inventors: Chun Yao Chen, Miao-Li County (TW); Jing Lin Zhang, Miao-Li County (TW)

Correspondence Address: BIRCH STEWART KOLASCH & BIRCH, PO BOX 747, FALLS CHURCH, VA, 22040-0747, US

(21) Appl. No.: 10/983,652

(22) Filed: Nov. 9, 2004

(30) Foreign Application Priority Data
Jul. 9, 2004 (TW) 093120654

(51) Int. Cl. G03B 21/00

(52) U.S. Cl. 353/70

(57) ABSTRACT

An adjustment apparatus comprises a base seat, sliding bracket and supporting stand, in which the lower surface of sliding bracket is contacted with the upper surface of the base seat and capable of being slid thereon. A mounting plate is installed at the upper end of the sliding bracket and a raised pin is projected on the surface of the mounting plate. The raised pin can be engaged with a rotating plate. A lens of an optical engine fixed and mounted on the surface of the rotating plate can be rotated levelly around the raised pin to do an adjustment to revise the rightward and leftward trapezoid deformation of an image projected on a screen. Besides, every kind of deformation can be revised by means of the multi-angles adjustment of a reflection mirror on the supporting stand installed at the front end of the sliding bracket.

### BACKGROUND OF THE INVENTION

1. Field of the Invention

The present invention relates to an adjustment apparatus, and more particularly to an adjustment apparatus for revising image deformation projected from an optical engine.

2. Description of Related Art

Please refer to FIG. 1. An optical engine is installed at the bottom of a housing 1 of a television set based on the rear projection principle of a Rear projection television. An image beam emitted from a lens 91 on the optical engine 90 is projected onto a small reflection mirror 3 and then reflected thereby to project onto a large reflection mirror 4. Finally, the beam is allowed to project onto a screen 5 disposed at the front end of the housing 1 of the television set to form images thereat. An optical adjustment for a television system need not be processed by a general user, because the optical engine 90 and the screen 5 of the rear projection television are combined into one body and the optical adjustment thereof is already processed when the rear projection television leaves the factory.

Because an image beam emitted from the lens 91 on the optical engine 90 of the rear projection television must be reflected through the reflection mirrors many times and can then be projected onto the screens 5 to form images thereat, the requirement of the tolerances of the relative positions, sizes and angles of a optical engine, reflection mirrors and a screen is very strict on the occasions of production, manufacturing and assembly of them, otherwise, an image deformation or deviation caused from the accumulation of tolerances might undoubtedly be happened. The adjustment procedure thereof is quite time consuming even if the image adjustment can be handled and revised by a quality control person after the event, this causes the quality control person in a production line to be very much persecuted.

Therefore, how to quickly revise the upward/downward or leftward/rightward trapezoid deformation or even more serious rhombus deformation of the image caused from the many times of reflections of the beam emitted from the optical engine is the topic of the present invention.

### SUMMARY OF THE INVENTION

One object of the present invention is to provide an adjustment apparatus, capable of adjusting a levelly rotating angle for an optical engine mounted thereon so that the leftward or rightward trapezoid deformation of an image projected on a screen can be revised.

Another object of the present invention is to provide an adjustment apparatus, capable of adjusting an image emitted from an optical engine to move leftward or rightward to allow the image to be projected onto the middle of a screen precisely.

Still another object of the present invention is to provide an adjustment apparatus, eliminating the influence of the errors of the manufacturing and assembly of a reflection plate on an image deformation together so as to improve the image deformation more effectively by forming an optical engine and an adjustment mechanism of the reflection plate into one body.

For attaining to the objects mentioned above, an adjustment apparatus according to the present invention comprises a base seat, sliding bracket and supporting stand, in which the lower surface of sliding bracket is contacted with the upper surface of the base seat and capable of being slid thereon. A mounting plate is installed at the upper end of the sliding bracket and a raised pin is projected on the surface of the mounting plate. The raised pin can be engaged with a rotating plate. A lens of an optical engine fixed and mounted on the surface of the rotating plate can be rotated levelly around the raised pin to do an adjustment to revise the rightward and leftward trapezoid deformation of an image projected on a screen after an image beam is emitted from the optical engine and reflected by mirrors between the optical engine and the screen. Besides, the upward/downward or leftward/rightward trapezoid deformation or even more serious rhombus deformation can be revised by means of the multi-angles adjustment of a reflection mirror on the supporting stand installed at the front end of the sliding bracket.

### BRIEF DESCRIPTION OF THE DRAWINGS

The present invention can be more fully understood by reference to the following description and accompanying drawings, in which:

FIG. 1 is a schematic view, showing a structure of a rear reflection television of the prior art;

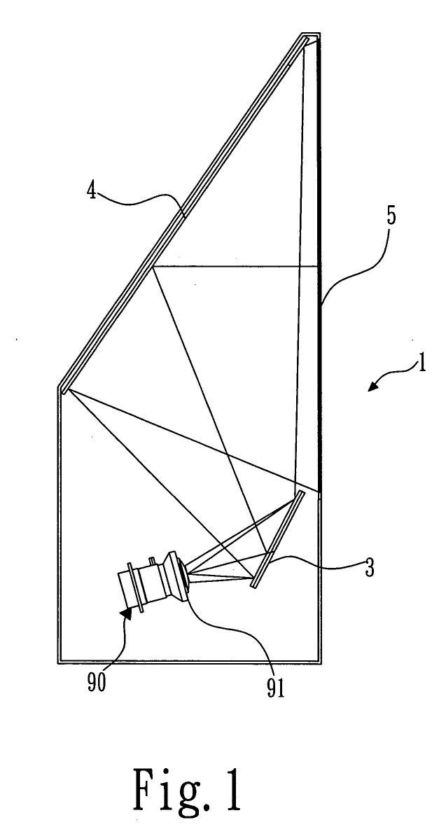

FIG. 2 is an explosive view, showing an adjustment apparatus of a preferred embodiment according to the present invention;

FIG. 3 is a prospective view, showing an adjustment apparatus of a preferred embodiment according to the present invention;

FIG. 4 is a schematic view, showing an adjustment state of a rotating plate of an adjustment apparatus of a preferred embodiment according to the present invention;

FIG. 5 is a prospective view, showing an assembly of an adjustment apparatus and supporting bracket of a preferred embodiment according to the present invention;

FIG. 6 is an explosive view, showing a supporting bracket and reflecting plate of a preferred embodiment according to the present invention; and

FIG. 7 is a schematic view, showing an adjustment of a reflecting plate of a preferred embodiment according to the present invention.

### DETAILED DESCRIPTION OF THE PREFERRED EMBODIMENTS

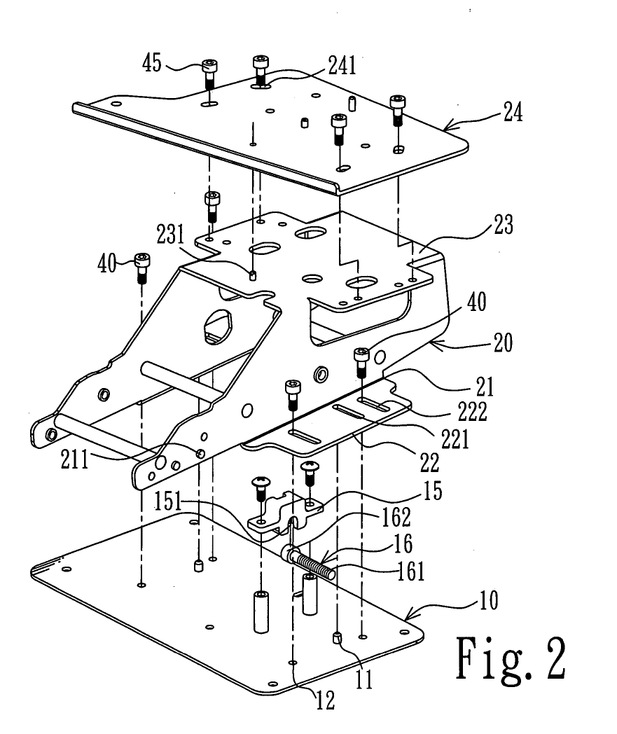

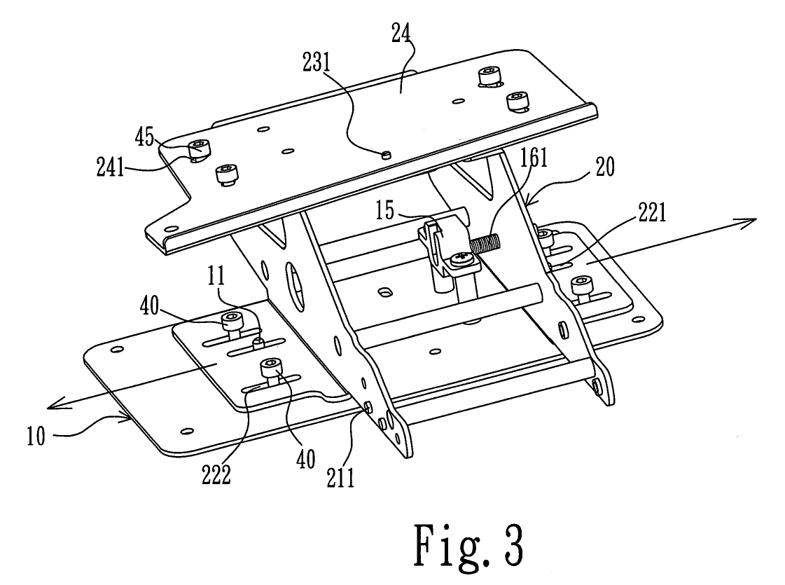

Please refer to FIGS. 2 and 3. An adjustment apparatus comprises a base seat 10, sliding bracket 20, mounting plate 23 and rotating plate 24, in which the base seat 10 is used for mounting corresponding components of the adjustment apparatus; a plurality of raised pillars 11 and fixing holes 12 are disposed at the surface of the base seat 10. A sliding plate 22 in which a plurality of parallel long through grooves 221 and long through holes 222 are opened is extended in a level direction at each side of the lower end 21 of the sliding bracket 20. The raised pillar 11 on the base seat 10 is passed through the long through groove 221 to allow the sliding bracket 20 to be moved linearly relative to the base seat 10, the longitudinal directions of both of the long through grooves 221 and the long through holes 222 are respectively parallel to an image picture (not shown in the figure) and the long through hole 222 is disposed correspondingly to the fixing hole 12 in the base seat 10; a fixing element 40 is passed through each long through hole 222 and locked in the fixing hole 12 in the base seat 10 so as to fix the sliding bracket 20 on the base seat 10. Besides, an adjusting seat 15 is installed on the surface of the base seat 10 and a notch 121 is disposed in the adjusting seat 15 for accepting an adjusting element 16; the adjusting element 16 can be a screw bolt. A screw end 161 of the adjusting element 16 is screwed to a screw hole (not shown in the figure) at a flank side of the sliding bracket 20, and a adjusting end 162 at another end thereof is engaged in the notch 151 in the adjusting seat 15. The mounting plate 23 is installed on the sliding bracket and a raised pin 231 is disposed on the center of one end of the mounting plate 23. A rotating plate 24 on which the optical engine is mounted is engaged on the raised pin 231. A plurality of circular arc grooves 241 are opened in the rotating plate 24 for one end of a second fixing element 45 to be passed through each circular arc groove 241 and fixed on the mounting plate 23.

When an image emitted from the optical engine is projected on a rightward or leftward deviated location of a screen, the first fixing element is first loosened, and a tool is then used to adjust the adjusting element 16 in the notch 151 of the adjusting seat 15. In the meantime, the adjusting end 162 of the adjusting element 16 is rotated in the notch 151 of the adjusting seat 15 by the guidance of the raised pillar 11 and the long through groove 221, and the sliding bracket 20 is driven by another screw end 161 to move in the longitudinal direction along the long through groove 221 and the long through hole 222 so that the leftward or the rightward deviated image on the screen can be revised and moved to the center of the screen gradually. Finally, the first fixing element 40 is rotated tightly to fix the sliding bracket 20 onto the base seat 10 after the adjustment is completed.

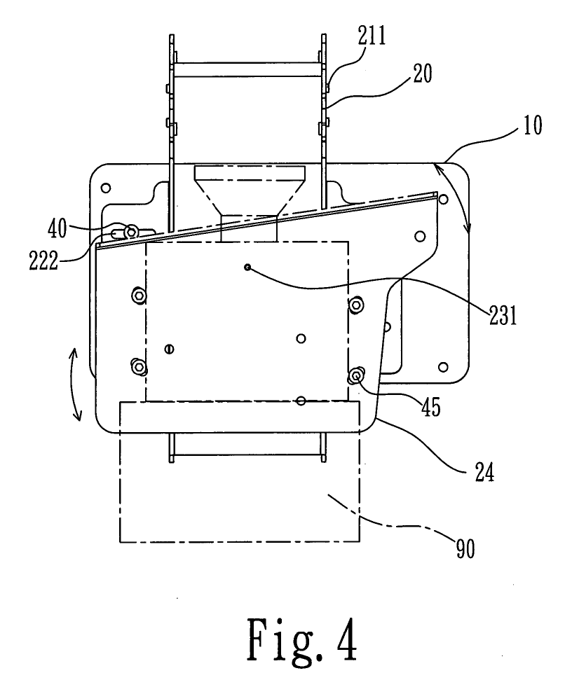

Please refer to FIG. 4. When an image projected on a screen through the optical engine 90 is leftward or rightward deformed, the second fixing element 45 is first loosened, and the rotating plate 24 is then rotated around the raised pin 231 so as to cause the level angle of the optical engine 90 fixed on the rotating plate 24 to be changed through the rotation of the rotating plate 24 to revise the leftward or rightward trapezoid deformation of the image. Finally, the second fixing element 45 is rotated tightly after the adjustment completed and the rotating plate 24 can then be allowed to fix on the mounting plate 23.

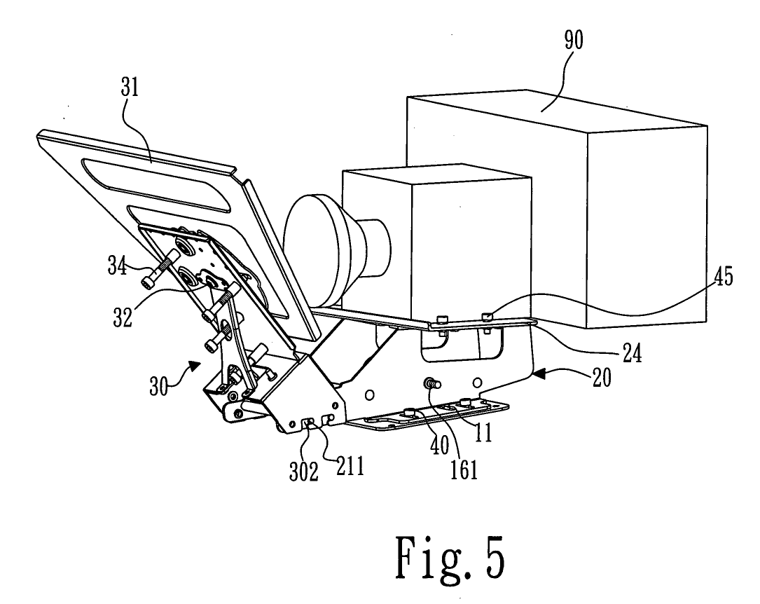

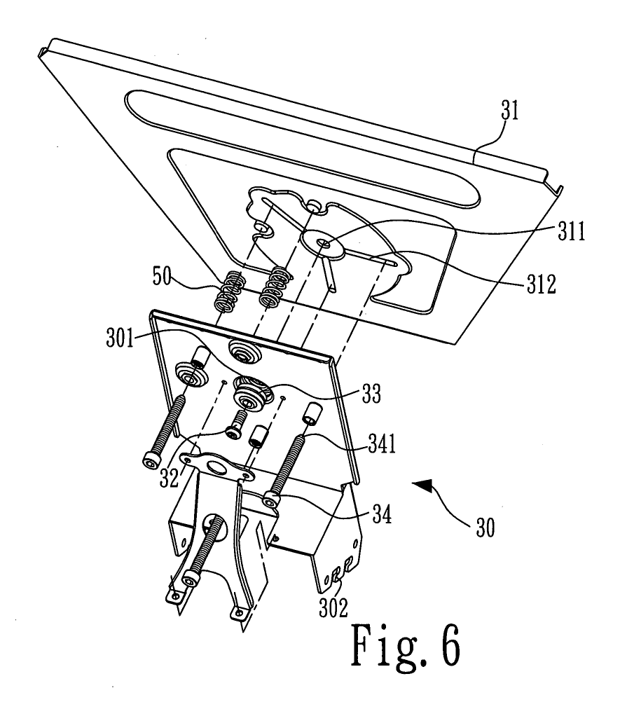

Please refer to FIG. 5. For promoting the adjustment function of the adjustment apparatus according to the present invention. The adjustment apparatus further comprises a supporting stand 30 on which an angle adjustable reflecting plate 31 is installed. Hooking pins 211 and hooked notches 302 are respectively at two sides of the front ends of the supporting stand 30 and sliding bracket 20 for allowing the supporting stand 30 to be fixed at the front end of the sliding bracket 20. Please refer to FIG. 6. The reflecting plate is inlayed in the supporting stand 30 and can also be a high albedo reflection mirror. A positioning hole 311 is disposed at the center of reverse side of the reflecting plate 31 and a fixing hole 301 is disposed at the surface at the upper end of the supporting stand 30. a bolt 32 cover with an elastic washer 33 is passed through the fixing hole 301 of the supporting stand 30 and screwed and fixed in the positioning hole 311 to allow the reflecting plate 31 to be fixed on the upper end of the supporting end 30 and the elastic washer 311 engaged with the bolt 32 is exactly inside the inner wall surface of the fixing hole 301. Furthermore, a plurality of long grooves 312 are disposed around the circumference of the positioning hole 311 of the reflecting plate 31 and a plurality of the adjusting rods 34 are screwed around the circumference of the fixing hole 301 of the supporting stand 30; a front end 341 of each adjusting rod 34 can just be correspondingly pressed against the inside of the long groove 312 of the reflecting plate 31 so that the reflecting plate 31 can be allowed to fix on the upper end of the supporting plate 30 with a fixed angle. And, a plurality of elastic elements are installed between the reflecting plate 31 and the supporting stand 30; the elastic element can be a spring 50. When the adjustment of any adjusting rod 34 pressed against the inside of the long groove 312 of the reflecting plate 31 is processed, the reflecting plate 31 can be controlled to deviate to an angle by means of the elastic tension of the spring 50 itself.

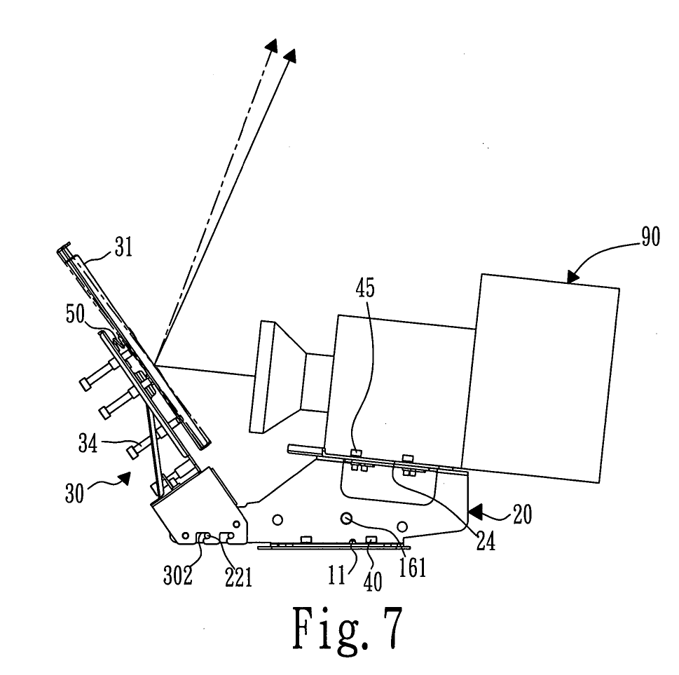

Please refer to FIG. 7. When an image projected from the optical engine 90 to a screen forms a upward/downward or leftward/rightward trapezoid deformation or even a rhombus deformation, the reflecting plate 31 on the supporting stand 30 must be adjusted to cause the angle of the image light reflected thereby to be relatively changed and then to attain to the revision of the upward/downward or leftward/rightward deformation or rhombus deformation of the image. Because the reflecting plate 31 is fixed by the bolt 32 surrounded with a elastic washer 33 and the elastic washer 33 is engaged in the inner wall of the fixing hole 301, the bolt 32 can be swung in the fixing hole 301, front ends of the three adjusting rods screwed at the upper of the rear side of the supporting stand 30 are respectively pressed against the inside of the long grooves 312. The reflecting plate 32 can be allowed to take the bolt 32 as a center to change the angle of the reflecting plate 31. For example, when the image projected from the optical engine 90 onto a screen is formed a upward/downward deformation, one of the adjusting rods 34 can be adjusted to extend or retreat by rotating it. Because the spring 50 is positioned between the reflecting plate 31 and the upper end of the supporting stand 30 when one of the adjusting rods 34 is rotated to retreat, the reflecting plate 31 is allowed to take the fixing hole 301 of the adjusting rod 32 as a fulcrum to be swung downward by the elastic force of the corresponding spring 50 itself to cause the front end of the retreated adjusting rod 34 can be kept pressing against the inside of the long groove 312 at the rear side of the reflecting plate 31 to cause the angle of depression of the reflecting plate 31 to changed. On the contrary, when the adjusting rod 34 is rotated to extend, the reflecting plate is pushed by the front end of the adjusting rod 34 to take the fixing hole 301 as a fulcrum to be swung upward and to cause the corresponding spring 50 to be contracted to cause the angle of elevation of the reflecting plate 31 to be changed so that the upward or downward deformation of the image can be revised. Similarly, when the image is formed to be leftward/rightward deformation or more serious rhombus deformation, it can be adjusted by extending or retreating all three adjusting rods 34.

Because the adjustment mechanism of the reflecting plate 31 is further added to collocate with the adjustment mechanism of the optical engine in the adjustment apparatus according to the present invention to improve the image deformation so that the adjustment mechanism of the optical engine 90 itself can be simplified. Besides, the influence of the errors of manufacturing and assembly of the reflecting plate 31 on the image deformation can also be eliminated by forming the adjustment mechanisms of the optical engine and the reflecting plate into one body.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An adjustment apparatus for mounting an optical engine, comprising:
a base seat;
a sliding bracket installed on said base seat, a guide element matched therewith and installed between said sliding bracket and said base seat for allowing said sliding bracket to move linearly relative to said base seat, and a mounting plate installed at the upper end of said sliding bracket, a raised pin disposed vertically on the surface of said mounting plate; and
a rotating plate installed on said mounting plate, one end thereof engaged with said raised pin for said rotating plate to be rotated around said raised pin, and said optical engine mounted and fixed on the upper surface of said rotating plate.

2. An adjustment apparatus according to claim 1, wherein a supporting stand is installed at one end of said base seat, and an angle adjustable reflecting plate is installed on said supporting stand.

3. An adjustment apparatus according to claim 1, wherein an adjusting seat is installed on said base seat, said adjusting seat is engaged with an adjusting element, one end of said adjusting element is screwed to the flank side of said sliding bracket so as to drive said sliding seat to move linearly relative to said base seat.

4. An adjustment apparatus according to claim 1, wherein said guide element is at least one long through groove and at least one raised pillar.

5. An adjustment apparatus according to claim 1, further comprising at least one first fixing element, and a long through hole opened on the surface of said sliding bracket, one end of said first fixing element being passed through said long through hole and locked on said base seat.

6. An adjustment apparatus according to claim 1, further comprising at least one second fixing element, and a circular arc groove opened on the surface of said sliding plate, one end of said second fixing element being passed through said circular arc groove and locked on said mounting plate.
